(19) United States
(12) Patent Application Publication
(10) Pub. No.: US 2013/0151995 A1
(43) Pub. Date: Jun. 13, 2013

(54) DISPLAY SYSTEM CAPABLE OF INTERNET ACCESSING, METHOD FOR INTERNET ACCESSING AND DISPLAYING OF WEBPAGE AND METHOD FOR CONTROLLING DISPLAY OF WEBPAGE

(71) Applicants: Sheue-Ling Hwang, Hsinchu City (TW); Chih-Hua Lin, Taipei City (TW); Ju-Ling Chen, Tainan City (TW); Ko-Chen Cheng, Taipei City (TW); Wan-Min Hsin, New Taipei City (TW); Jung-Hua Shen, Taipei City (TW)

(72) Inventors: Sheue-Ling Hwang, Hsinchu City (TW); Chih-Hua Lin, Taipei City (TW); Ju-Ling Chen, Tainan City (TW); Ko-Chen Cheng, Taipei City (TW); Wan-Min Hsin, New Taipei City (TW); Jung-Hua Shen, Taipei City (TW)

(21) Appl. No.: 13/315,297

(22) Filed: Dec. 9, 2011

(51) Int. Cl. G06F 3/01

(52) U.S. Cl. 715/760

(57) ABSTRACT

A display system includes a receiver and a display. The receiver is used for receiving a control signal from a remote controller. The display is used for displaying a list of webpage options with numbers associating with the, and displaying a webpage associated with a webpage option after receiving the control signal indicating a number corresponding to the webpage option. The number is entered through pressing a numerical keypad of the remote controller.

### BACKGROUND

Nowadays, a user can connect to the Internet utilizing a portable device, a desktop, or a notebook. Moreover, the user can also access website contents utilizing an Internet capable television. The user controls a cursor displayed on the TV screen with directional buttons of a remote controller. The directional buttons are used to control the cursor to move up, down, left, and right. It is more difficult and also takes more time to move the cursor with the directional buttons comparing to a mouse or touch screen.

### SUMMARY

An embodiment provides a display system. The display system includes a receiver and a display. The receiver is used for receiving a control signal from a remote controller. The display is used for displaying a list of webpage options with numbers associated with the webpage options, and displaying a webpage associated with a webpage option after receiving the control signal indicating a number corresponding to the webpage option. The number is entered through pressing a numerical keypad of the remote controller.

Another embodiment provides a method for Internet accessing and displaying of a webpage. The method includes receiving a number from a remote controller to select a webpage option associated with the number; displaying a webpage associated with the webpage option.

Another embodiment provides a method for controlling display of webpage. The method includes associating a list of webpage options with numbers; displaying the list of webpage options with the numbers associated with the webpage options on a display; displaying a webpage associated with a webpage option on the display after a number associated with the webpage option is entered through a numerical keypad.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a display system capable of Internet accessing according to an embodiment.

FIG. 2A is a diagram illustrating an exemplary list of webpage options.

FIG. 2B is a diagram illustrating an exemplary list of webpage options of a selected webpage option.

FIG. 2C is a diagram illustrating an exemplary list of display options of a selected webpage option.

FIG. 3A is a diagram illustrating an exemplary list of webpage options of an auction website.

FIG. 3B is a diagram illustrating an exemplary list of webpage options of a “3C appliances”.

FIG. 3C is a diagram illustrating an exemplary list of webpage options of a “television”.

FIG. 3D is a diagram illustrating a webpage corresponding to television models under the “proposed super hot model”.

FIG. 3E is a diagram illustrating seller data corresponding to the “44-inch Plasma TV”.

FIG. 4A is a diagram illustrating an exemplary list of webpage options of a tourism website.

FIG. 4B is a diagram illustrating an exemplary list of webpage options of a “domestic tourism”.

FIG. 4C is a diagram illustrating an exemplary list of webpage options of an “Ilan”.

FIG. 4D is a diagram illustrating a webpage corresponding to prices under the “ecological environment tourism”.

FIG. 4E is a diagram illustrating a webpage corresponding to a detailed itinerary of the “Wushih harbor (1 day tourism)”.

FIG. 5A is a diagram illustrating an exemplary list of webpage options of an album website.

FIG. 5B is a diagram illustrating an exemplary list of webpage options of a “view public photo”.

FIG. 5C is a diagram illustrating an exemplary webpage options of a “wedding”.

FIG. 5D is a diagram illustrating an exemplary list of webpage options of “album 1”.

FIG. 5E is a diagram illustrating a first photo of the album 1.

FIG. 6 is a flowchart illustrating a method for controlling display of webpage contents according to another embodiment.

### DETAILED DESCRIPTION

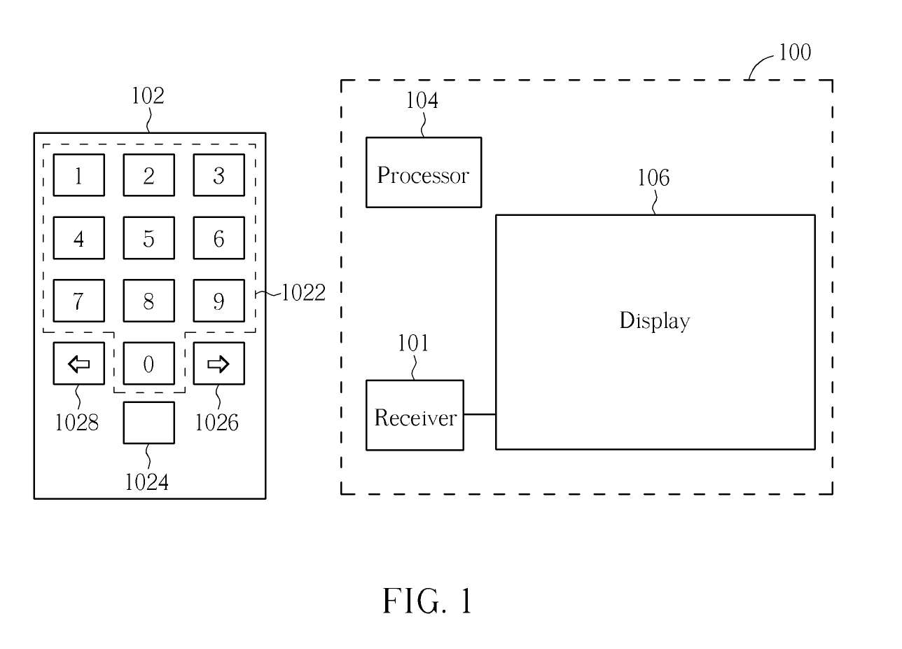

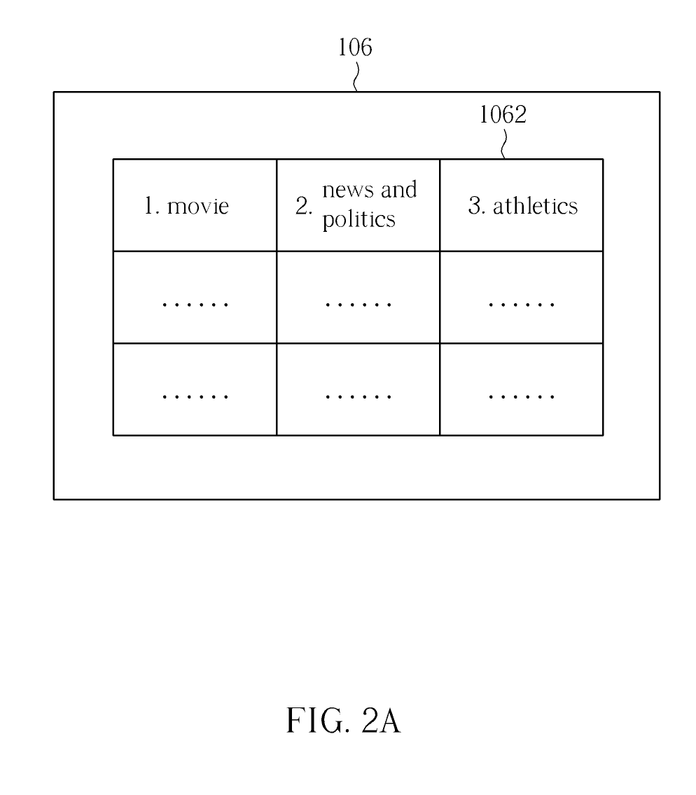

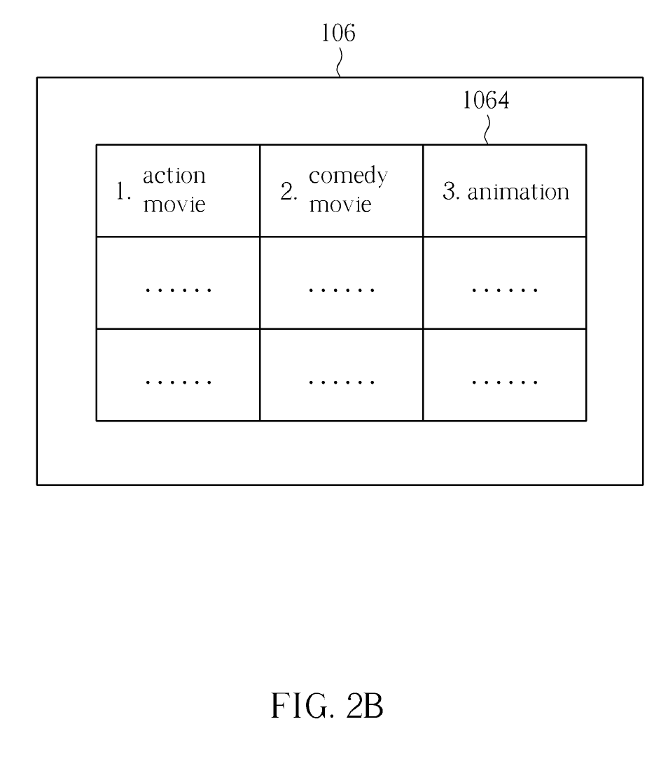

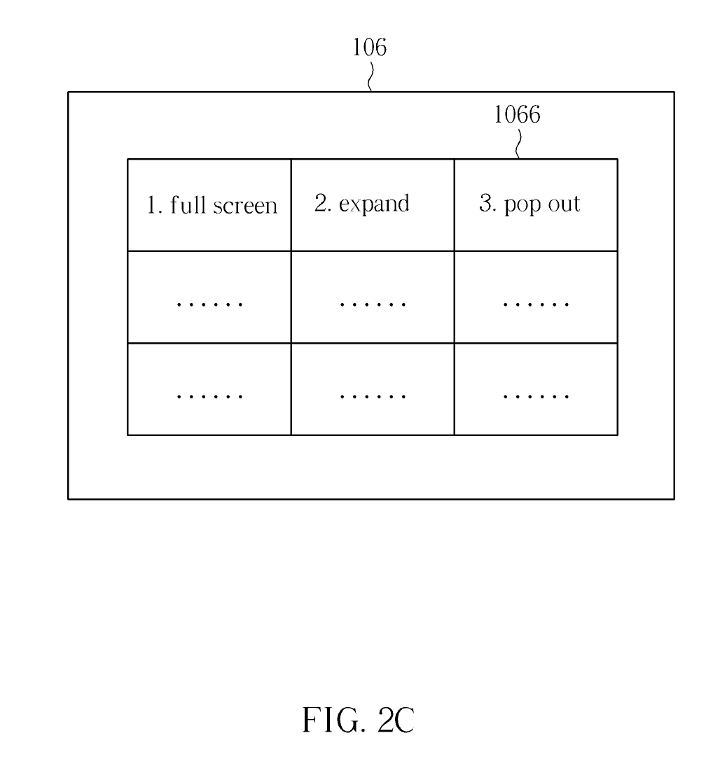

FIG. 1 is a diagram of a display system 100 capable of Internet accessing according to an embodiment, FIG. 2A is a diagram illustrating an exemplary list 1062 of webpage options, FIG. 2B is a diagram illustrating an exemplary list 1064 of webpage options, and FIG. 2C is a diagram illustrating an exemplary list 1066 of display options of a selected webpage option. As shown in FIG. 1, the display system 100 includes a receiver 101, a processor 104 and a display 106, where the display 106 can be a television screen. However, the present invention is not limited to the display 106 being the television screen. The display 106 is used for displaying a list of webpage options with numbers associated with the webpage options, and displaying a webpage associated with a webpage option after receiving a control signal indicating a number corresponding to the webpage option, where the number is entered by a user through pressing a numerical keypad 1022 of a remote controller 102 (as shown in FIG. 1). In some embodiments, the processor 104 retrieves information of a webpage from the Internet after the receiver 101 receives the control signal, the processor 104 associates the list of the webpage options with the numbers. The receiver 101 is used for receiving a control signal from the remote controller 102 and receiving a request generated by the remote controller 102 for triggering display of the list of webpage options. In addition, the present invention is not limited to the processor 104 associating the list of the webpage options with the numbers. That is, a server or an Internet Service Provider can also associate the list of the webpage options with the numbers, or associating the list of the webpage options with the numbers can be determined according to frequencies of the webpage options being selected through the remote controller 102. In addition, the webpage options with the numbers can be default webpage options, manually set by the user, be provided by the server or the Internet Service Provider, or be determined according to frequencies of the webpage options being selected through the remote controller 102. In addition, in another embodiment of the present invention, the display system 100 includes the remote controller 102.

As shown in FIG. 1, the remote controller 102 includes the numerical keypad 1022, a menu button 1024, a right-arrow button 1026, and a left-arrow button 1028. The numerical keypad 1022 includes 10 number buttons from 0 to 9 for entering a number associated with a webpage option of a list displayed on the display 106. A user can utilize the menu button 1024 to trigger or hide the lists 1062, 1064, 1066 on the display 106. That is, the user presses the menu button 1024 to trigger the display 106 to display one of the lists 1062, 1064, 1066. In addition, when the user presses the menu button 1024 again, the receiver 101 receives a request generated by the menu button 1024 to trigger the display 106 to hide the list 1062, 1064, 1066. The left-arrow button 1028 is used for requesting the display 106 to display a previous webpage, and the right-arrow button 1026 is used for requesting the display 106 to display a next webpage, or vice verse. In another embodiment of the present invention, the remote controller 102 includes a page-up button and a page-down button, where the page-up button is used for requesting the display 106 to display a previous page and the page-down button is used for requesting the display 106 to display a next page, or vice verse.

The processor 104 is used for associating the list 1062 of the webpage options with numbers (an example is shown in FIG. 2A), associating the list 1064 of the webpage options with numbers (an example is shown in FIG. 2B), and associating the list 1066 of the display options with numbers (an example is shown in FIG. 2C). The processor 104 can associate the list 1062 of the webpage options with the numbers before or after the receiver 101 receiving a request for triggering display of the list 1062 of the webpage options generated by the menu button 1024 of the remote controller 102. Then, the display 106 can display the list 1062 of the webpage options with the numbers after receiving a control signal from the remote controller 102.

As shown in FIG. 2A, the exemplary list 1062 of the webpage options includes “movie” corresponding to 1, “news and politics” corresponding to 2, “athletics” corresponding to 3, and so on. However, this embodiment is not limited to the webpage options and corresponding order shown in FIG. 2A. When the user presses the number button “1” (that is, number 1 is selected), the display 106 can enter the “movie” webpage and the receiver 101 can trigger display of the list 1064 of the webpage options under the “movie” webpage (as shown in FIG. 2B). The processor 104 can associate the list 1064 of webpage options with numbers before or after the receiver 101 receiving a request generated by the number button “1”. As shown in FIG. 2B, the exemplary list 1064 of the webpage options of the “movie” webpage includes “action movie” corresponding to 1, “comedy movie” corresponding to 2, “animation” corresponding to 3, and so on. In addition, when the display 106 displays the list 1064 of the webpage options and the user wants the display 106 to display the list 1062 of the webpage options, the user can press the left-arrow button 1028 to return to the list 1062 of the webpage options. In addition, when the display 106 displays the list 1064 of the webpage options and the user wants to hide the list 1064 of the webpage options, the user can press the menu button 1024 to hide the list 1064 of the webpage options. When the user presses the number button “1” (that is, number 1 is selected), the display 106 can enter the “action movie” webpage and the receiver 101 can trigger display of the exemplary list 1066 of the display options of the “action movie” webpage (as shown in FIG. 2C) . The processor 104 can associate the list 1066 of the display options with numbers before or after the receiver 101 receiving a request generated by the number button “1” . As shown in FIG. 2C, the list 1066 of the display options of the “action movie” webpage includes “full screen” corresponding to 1, “expand” corresponding to 2, “pop out” corresponding to 3, and so on. When the user presses the number button “1” (that is, number 1 is selected) , the display 106 displays the “action movie” according to the “full screen” function. The user can press the menu button 1024 to hide the list 1066 of the display options of the “action movie” webpage. In addition, when the display 106 displays the list 1066 of the display options and the user wants to view the list 1064 of the webpage options, the user can press the left-arrow button 1028 to return to the list 1064 of webpage options. In addition, when the display 106 displays the list 1066 of the display options and the user wants to hide the list 1066 of the display options, the user can press the menu button 1024 to hide the list 1066 of the display options. In addition, the lists 1062, 1064, and 1066 are not limited to style boxes.

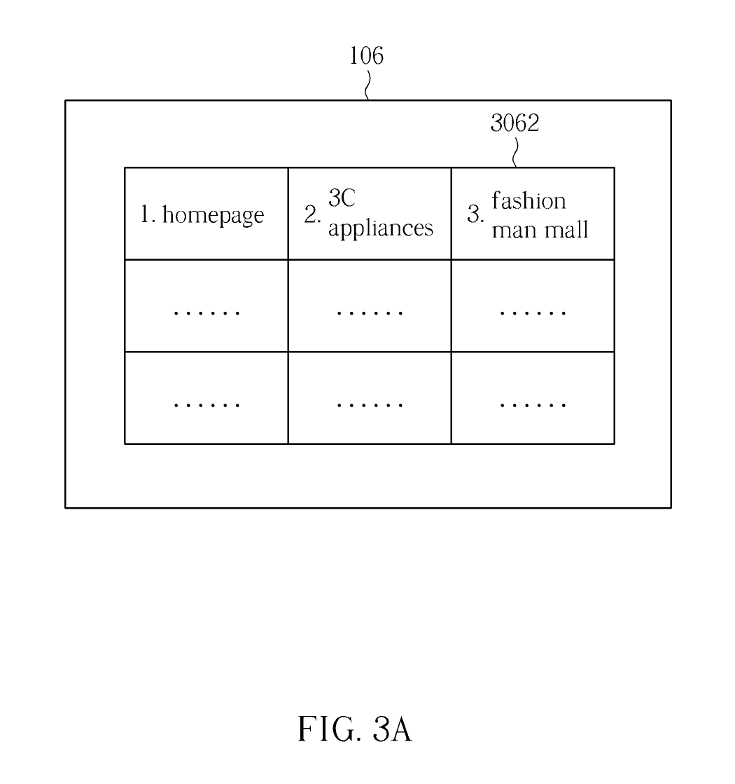

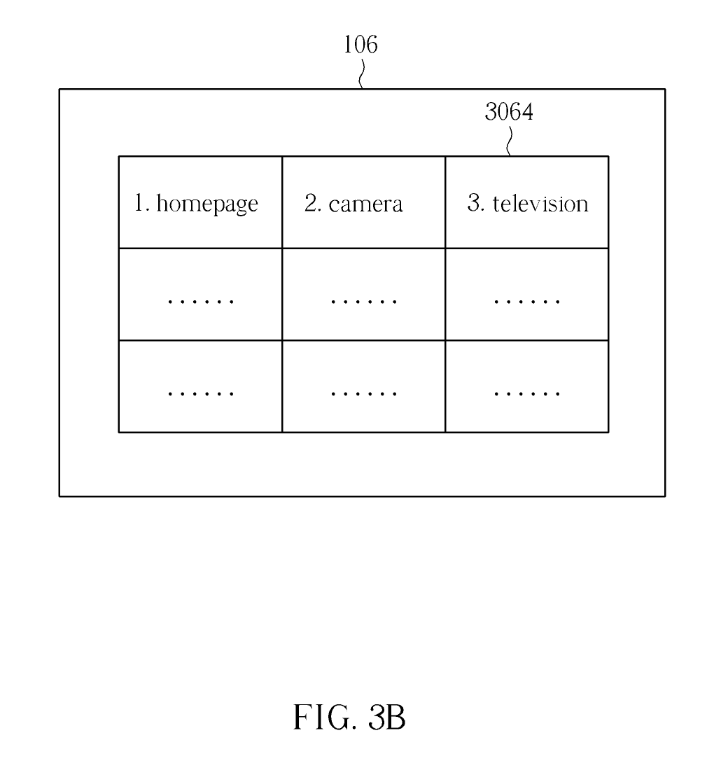

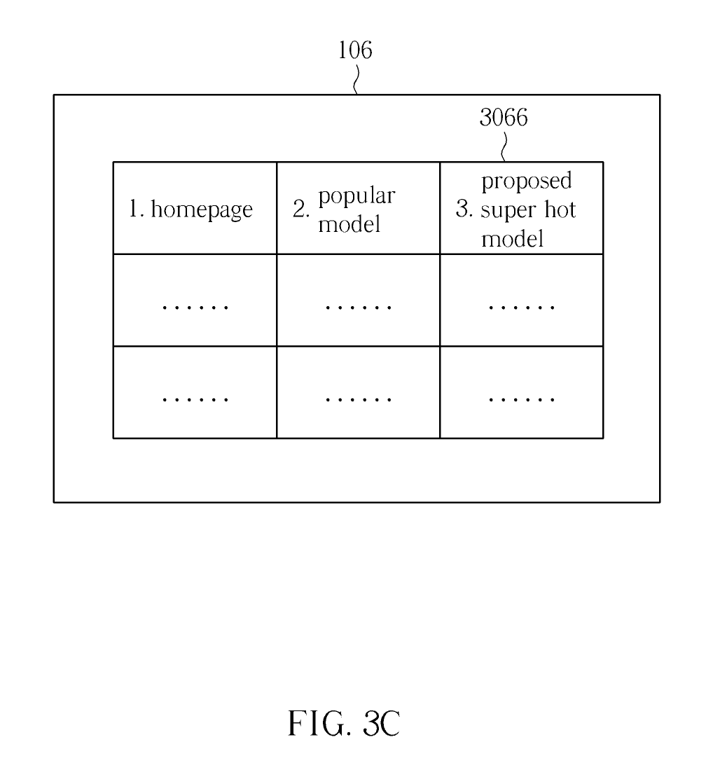

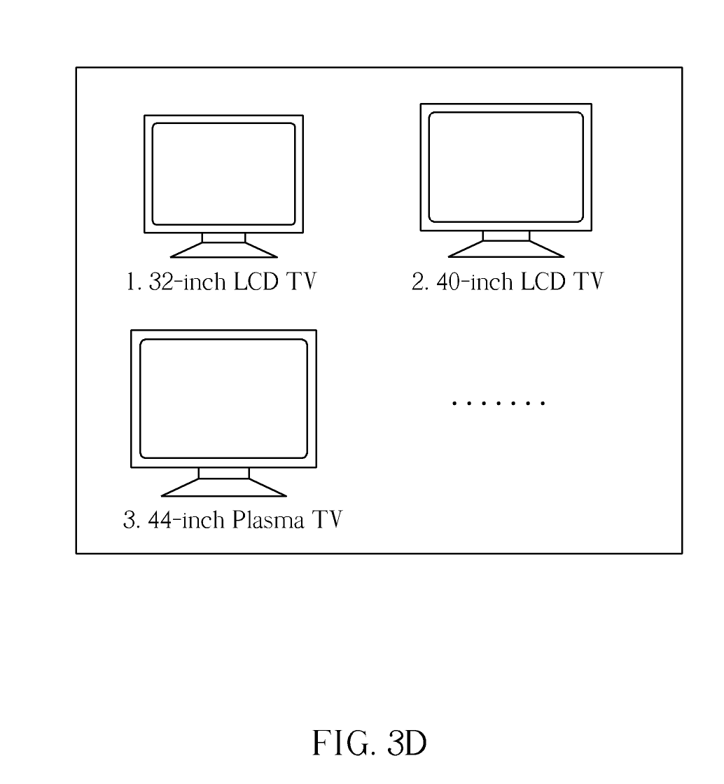

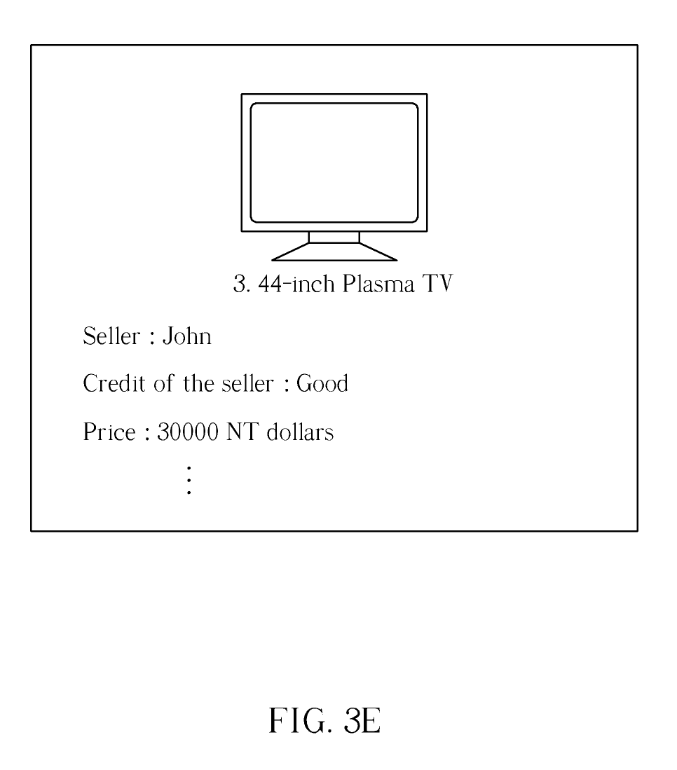

FIG. 3A is a diagram illustrating an exemplary list 3062 of webpage options of an auction website, FIG. 3B is a diagram illustrating an exemplary list 3064 of webpage options of a “3C appliances”, FIG. 3C is a diagram illustrating an exemplary list 3066 of webpage options of a “television”, FIG. 3D is a diagram illustrating a webpage corresponding to television models under the “proposed super hot model”, and FIG. 3E is a diagram illustrating seller data corresponding to the “44-inch Plasma TV”. The user can utilize the menu button 1024 to display or hide the lists 3062, 3064, 3066 on the display 106. In addition, when the user presses the menu button 1024 again, the receiver 101 receives a request generated by the menu button 1024 to trigger the display 106 to hide the lists 3062, 3064, 3066. In addition, the webpage options with the numbers can be default webpage options, manually set by the user, be provided by the server or the Internet Service Provider, or be determined according to frequencies of the webpage options being selected through the remote controller 102.

As shown in FIG. 3A, the exemplary list 3062 includes “homepage” corresponding to 1, “3C appliances” corresponding to 2, “fashion man mall” corresponding to 3, and so on. However, this embodiment is not limited to the webpage options and corresponding order shown in FIG. 3A. When the user presses the number button “2” (that is, number 2 is selected), the display 106 can enter the “3C appliances” and the receiver 101 can trigger display of the list 3064 under the “3C appliances” (as shown in FIG. 3B). As shown in FIG. 3B, the exemplary list 3064 of the webpage options of the “3C appliances” includes “homepage” corresponding to 1, “camera” corresponding to 2, “television” corresponding to 3, and so on. In addition, when the display 106 displays the list 3064 and the user wants the display 106 to display the list 3062 again, the user can press the left-arrow button 1028 to return to the list 3062. In addition, when the display 106 displays the list 3064 and the user wants to hide the list 3064, the user can press the menu button 1024 to hide the list 3064. When the user presses the number button “3”, the display 106 can enter the “television” and the receiver 101 can trigger display of the exemplary list 3066 under the “television” (as shown in FIG. 3C). As shown in FIG. 3C, the list 3066 includes “homepage” corresponding to 1, “popular model” corresponding to 2, “proposed super hot model” corresponding to 3, and so on. When the user presses the number button “3”, the display 106 displays the webpage corresponding to television models under the “proposed super hot model” according to a request generated by the number button “3”. As shown in FIG. 3D, the webpage corresponding to the television models under the “proposed super hot model” includes “32-inch LCD TV” corresponding to 1, “40-inch LCD TV” corresponding to 2, “44-inch Plasma TV” corresponding to 3, and so on. When the user presses the number button “3”, the display 106 can show the seller data corresponding to the “44-inch Plasma TV” (as shown in FIG. 3E). The seller data includes a user name of the seller, credit of the seller, a price of the “44-inch Plasma TV, and so on. In addition, when the display 106 displays the list 3066 and the user wants to view the list 3064 again, the user can press the left-arrow button 1028 to return to the list 3064. In addition, when the display 106 displays the list 3066 and the user wants to hide the list 3066, the user can press the menu button 1024 to hide the list 3066. In addition, the lists 3062, 3064, and 3066 are not limited to style boxes.

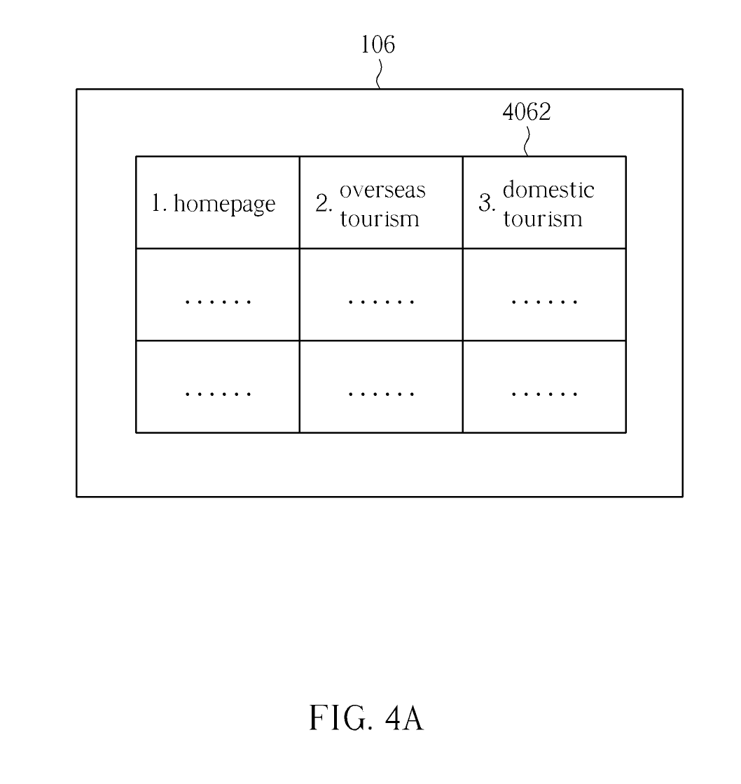

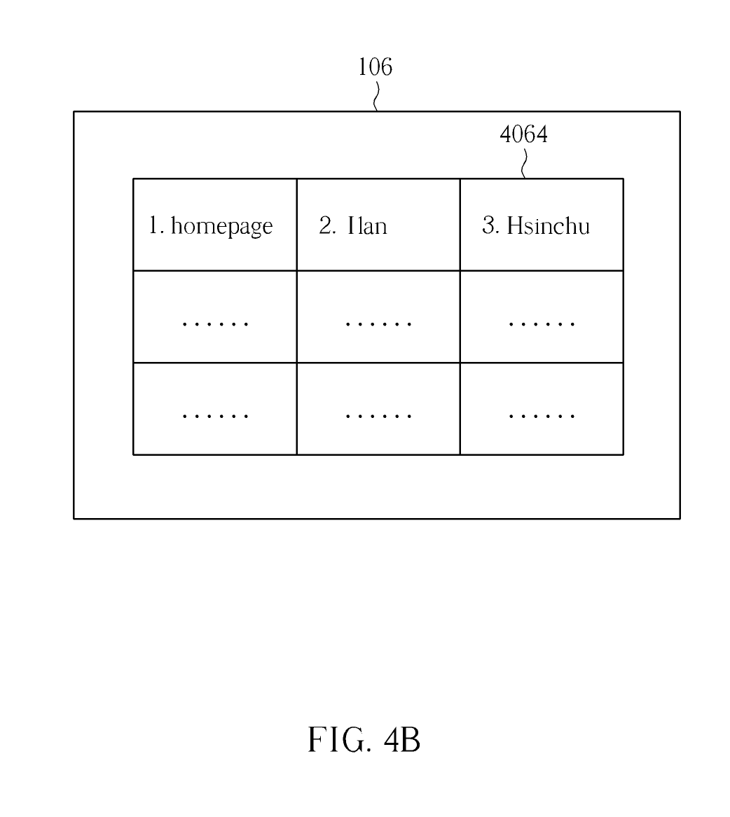

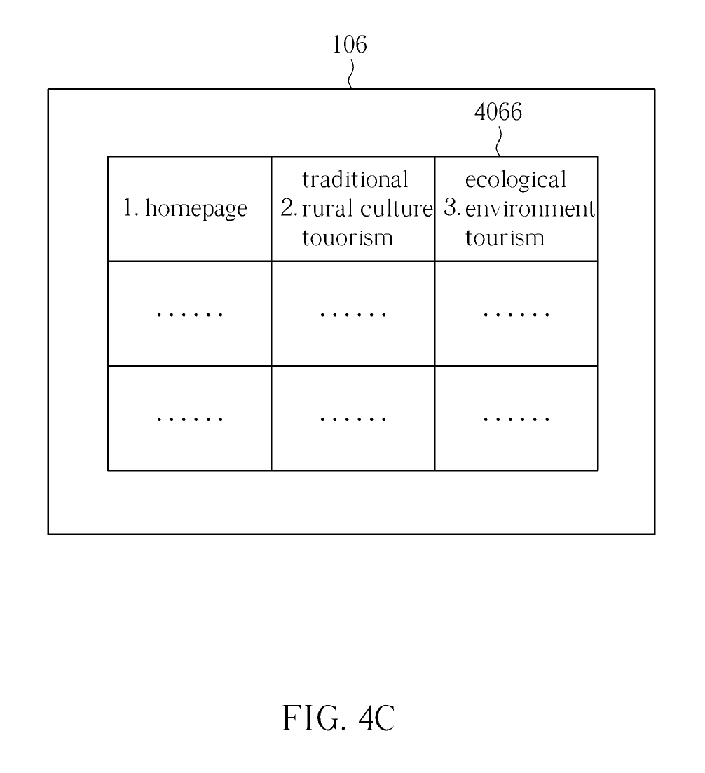

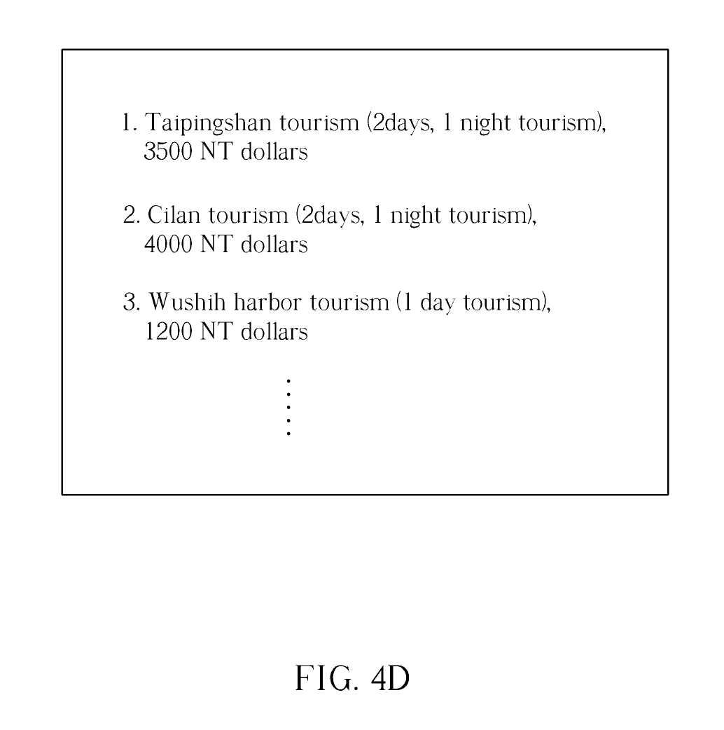

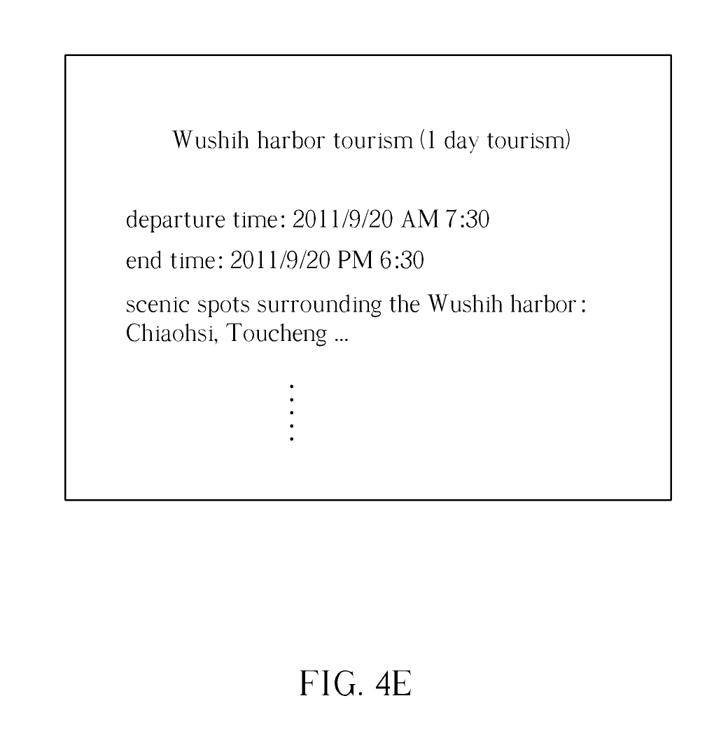

FIG. 4A is a diagram illustrating an exemplary list 4062 of webpage options of a tourism website, FIG. 4B is a diagram illustrating an exemplary list 4064 of webpage options of a “domestic tourism”, FIG. 4C is a diagram illustrating an exemplary list 4066 of webpage options of an “Ilan”, FIG. 4D is a diagram illustrating a webpage corresponding to prices under the “ecological environment tourism”, and FIG. 4E is a diagram illustrating a webpage corresponding to a detailed itinerary of the “Wushih harbor (1 day tourism)”. The user can utilize the menu button 1024 to display or hide the lists 4062, 4064, 4066 on the display 106. In addition, when the user presses the menu button 1024 again, the receiver 101 receives a request generated by the menu button 1024 to trigger the display 106 to hide the list 4062, 4064, 4066. In addition, the webpage options with the numbers can be default webpage options, manually set by the user, be provided by the server or the Internet Service Provider, or be determined according to frequencies of the webpage options being selected through the remote controller 102.

As shown in FIG. 4A, the exemplary list 4062 includes “homepage” corresponding to 1, “overseas tourism” corresponding to 2, “domestic tourism” corresponding to 3, and so on. However, this embodiment is not limited to the webpage options and corresponding order shown in FIG. 4A. When the user presses the number button “3” (that is, number 3 is selected), the display 106 can enter the “domestic tourism” and the receiver 101 can trigger display of the list 4064 under the “domestic tourism” (as shown in FIG. 4B). As shown in FIG. 4B, the exemplary list 4064 of the webpage options of the “domestic tourism” includes “homepage” corresponding to 1, “Ilan” corresponding to 2, “Hsinchu” corresponding to 3, and so on. In addition, when the display 106 displays the list 4064 and the user wants the display 106 to display the list 4062 again, the user can press the left-arrow button 1028 to return to the list 4062. In addition, when the display 106 displays the list 4064 and the user wants to hide the list 4064, the user can press the menu button 1024 to hide the list 4064. When the user presses the number button “2”, the display 106 can enter the “Ilan” and the receiver 101 can trigger display of the exemplary list 4066 under the “Ilan” (as shown in FIG. 4C). As shown in FIG. 4C, the list 4066 includes “homepage” corresponding to 1, “traditional rural culture tourism” corresponding to 2, “ecological environment tourism” corresponding to 3, and so on. When the user presses the number button “3”, the display 106 displays the webpage corresponding to prices under the “ecological environment tourism” according to a request generated by the number button “3” . As shown in FIG. 4D, the webpage corresponding to the prices under the “ecological environment tourism” includes “Taipingshan tourism (2days, 1 night tourism), 3500 NT dollars” corresponding to 1, “Cilan tourism (2days, 1 night tourism), 4000 NT dollars” corresponding to 2, “Wushih harbor tourism (1 day tourism), 1200 NT dollars” corresponding to 3, and so on. When the user presses the number button “3”, the display 106 can show the detailed itinerary of the “Wushih harbor tourism (1 day tourism)” (as shown in FIG. 4E). The detailed itinerary of the “Wushih harbor tourism (1 day tourism)” includes departure time, end time, scenic spots surrounding the Wushih harbor, and so on. Therefore, the user can browse the detailed itinerary of the “Wushih harbor to determine whether to buy the “Wushih harbor (1 day tourism) ” or not. In addition, when the display 106 displays the list 4066 and the user wants to view the list 4064 again, the user can press the left-arrow button 1028 to return to the list 4064. In addition, when the display 106 displays the list 4066 and the user wants to hide the list 4066, the user can press the menu button 1024 to hide the list 4066. In addition, the lists 4062, 4064, and 4066 are not limited to style boxes.

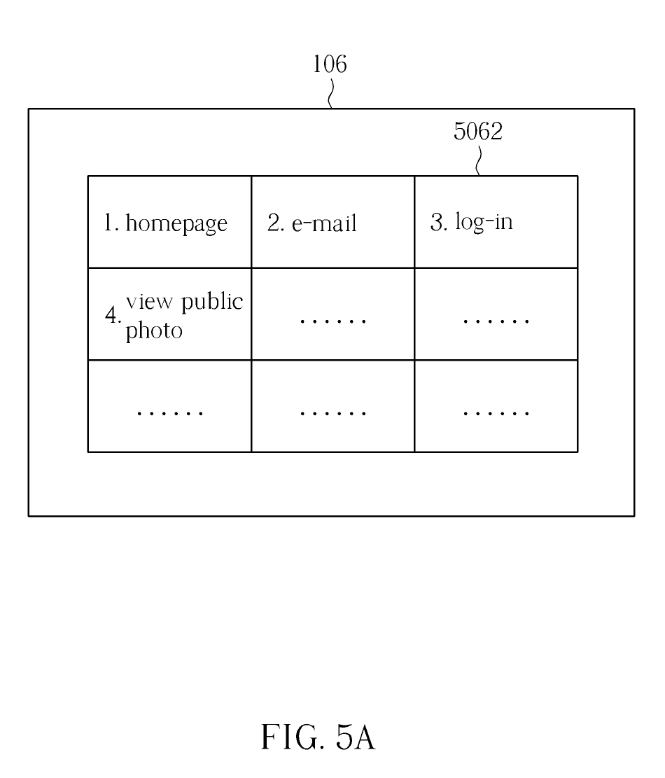

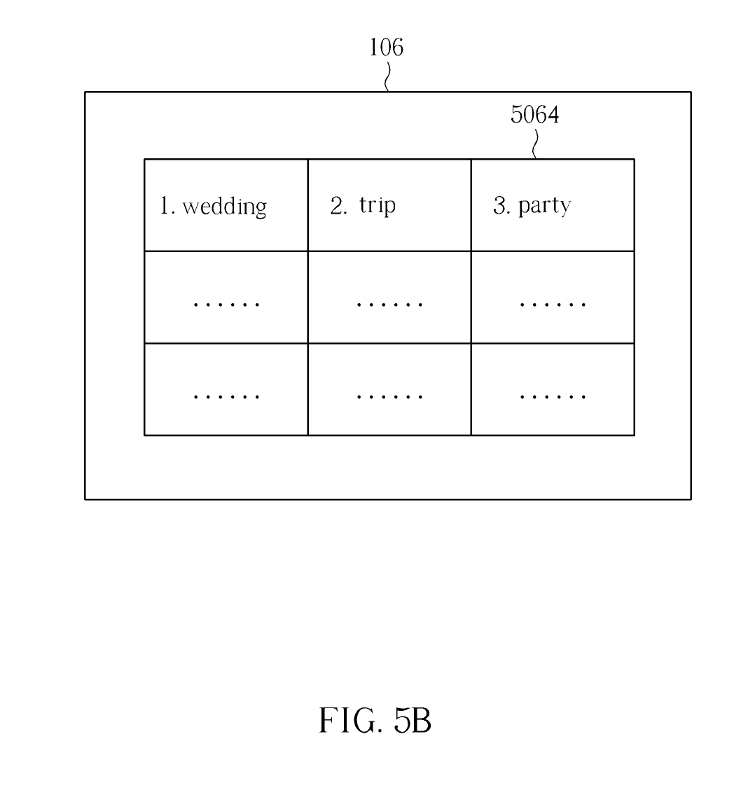

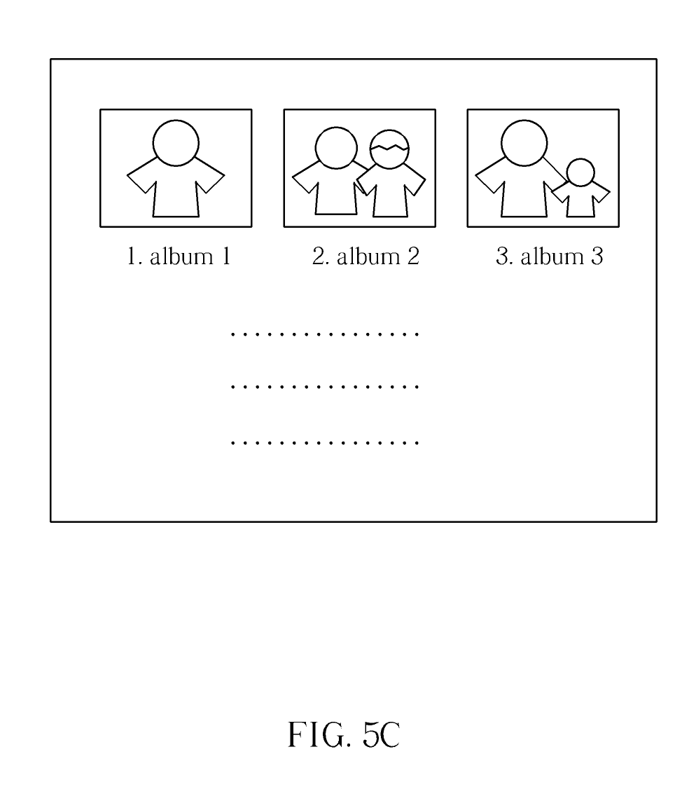

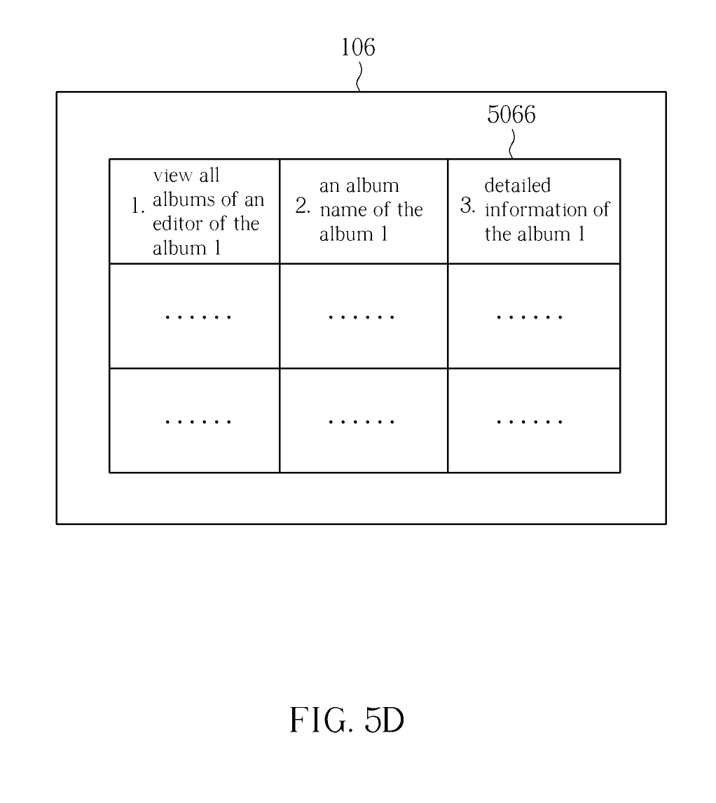

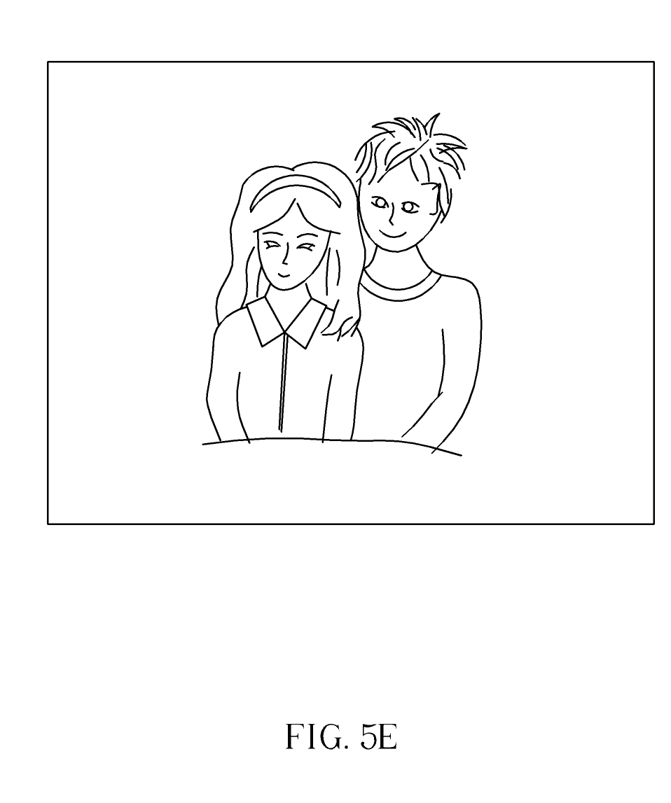

FIG. 5A is a diagram illustrating an exemplary list 5062 of webpage options of an album website, FIG. 5B is a diagram illustrating an exemplary list 5064 of webpage options of a “view public photo”, FIG. 5C is a diagram illustrating an exemplary webpage options of a “wedding”, FIG. 5D is a diagram illustrating an exemplary list 5066 of webpage options of “album 1”, and FIG. 5E is a diagram illustrating a first photo of the album 1. The user can utilize the menu button 1024 to display or hide the lists 5062, 5064, 5066 on the display 106. In addition, when the user presses the menu button 1024 again, the receiver 101 receives a request generated by the menu button 1024 to trigger the display 106 to hide the list 5062, 5064, 5066. In addition, the webpage options with the numbers can be default webpage options, manually set by the user, be provided by the server or the Internet Service Provider, or be determined according to frequencies of the webpage options being selected through the remote controller 102.

As shown in FIG. 5A, the exemplary list 5062 includes “homepage” corresponding to 1, “e-mail” corresponding to 2, “log-in” corresponding to 3, “view public photo” corresponding to 4, and so on. However, this embodiment is not limited to the webpage options and corresponding order shown in FIG. 5A. When the user presses the number button “4” (that is, number 4 is selected), the display 106 can enter the “view public photo” and the receiver 101 can trigger display of the list 5064 under the “view public photo” (as shown in FIG. 5B). As shown in FIG. 5B, the exemplary list 5064 of the webpage options of the “view public photo” includes “wedding” corresponding to 1, “trip” corresponding to 2, “party” corresponding to 3, and so on. In addition, when the display 106 displays the list 5064 and the user wants the display 106 to display the list 5062 again, the user can press the left-arrow button 1028 to return to the list 5062. In addition, when the display 106 displays the list 5064 and the user wants to hide the list 5064, the user can press the menu button 1024 to hide the list 5064. When the user presses the number button “1”, the display 106 can enter the “wedding” to trigger display of the exemplary webpage options under the “wedding” (as shown in FIG. 5C). As shown in FIG. 5C, the exemplary webpage options include “album 1” corresponding to 1, “album 2” corresponding to 2, “album 3” corresponding to 3, and so on. When the user presses the number button “1”, the display 106 can enter the “album 1” and the receiver 101 can trigger display of the exemplary list 5066 of webpage options of the “album 1”. As shown in FIG. 5D, the exemplary list 5066 includes “view all albums of an editor of the album 1” corresponding to 1, “an album name of the 1” corresponding to 2, “detailed information of the album 1” corresponding to 3, and so on. When the user presses the menu button 1024, the receiver 101 receives a request generated by the menu button 1024 to trigger the display 106 to hide the list 5066, so the display 106 can show the first photo of the album 1 (as shown in FIG. 5E). In addition, the user can view other photos of the album 1 through the left-arrow button 1028 and the right-arrow button 1026. In addition, when the display 106 displays the list 5066 and the user wants to view the list 5064 again, the user can press the left-arrow button 1028 to return to the list 5064. In addition, when the display 106 displays the list 5066 and the user wants to hide the list 5066, the user can press the menu button 1024 to hide the list 5066. In addition, the lists 5062, 5064, and 5066 are not limited to style boxes.

In addition, any display system which utilizes the remote controller described in the present invention to select display operations of the display system falls within the scope of the present invention.

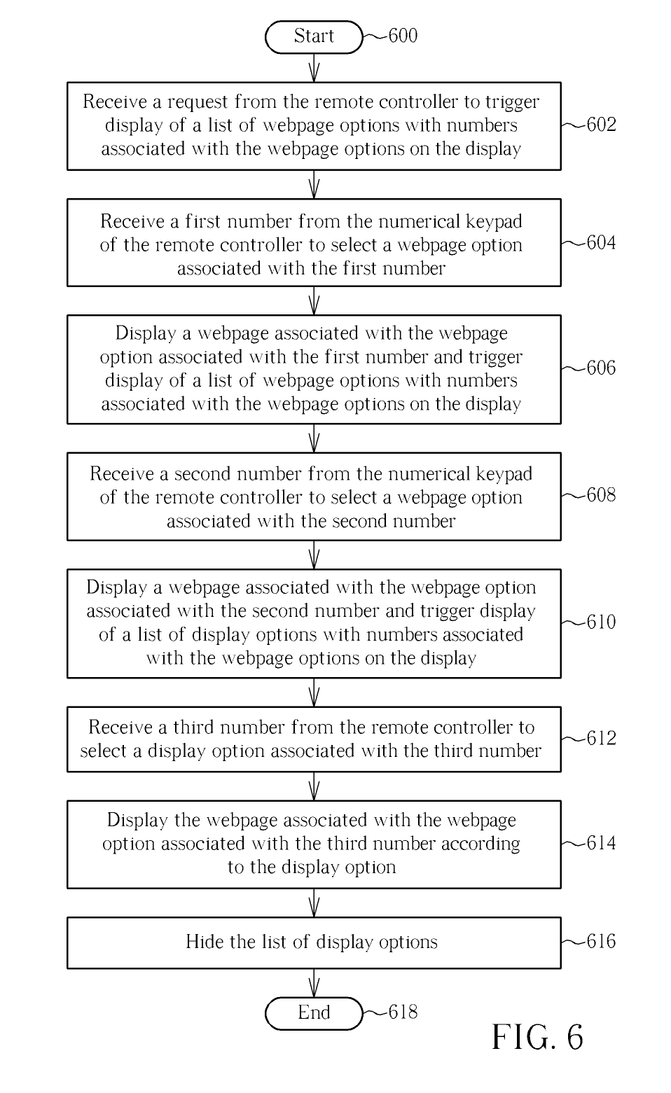

Please refer to FIG. 6 and FIG. 1. FIG. 6 is a flowchart illustrating a method for controlling display of webpage contents according to another embodiment. The method in FIG. 6 is illustrated using the display system 100 in FIG. 1 and includes the following steps:

Step 600: Start.

Step 602: Receive a request from the remote controller 102 to trigger display of a list 1062 of webpage options with numbers associated with the webpage options on the display 106.

Step 604: Receive a first number from the numerical keypad 1022 of the remote controller 102 to select a webpage option associated with the first number.

Step 606: Display a webpage associated with the webpage option associated with the first number and trigger display of a list 1064 of webpage options with numbers associated with the webpage options on the display 106.

Step 608: Receive a second number from the numerical keypad 1022 of the remote controller 102 to select a webpage option associated with the second number.

Step 610: Display a webpage associated with the webpage option associated with the second number and trigger display of a list 1066 of display options with numbers associated with the webpage options on the display 106.

Step 612: Receive a third number from the remote controller 102 to select a display option associated with the third number.

Step 614: Display the webpage associated with the webpage option associated with the third number according to the display option.

Step 616: Hide the list 1066 of display options.

Step 618: End.

The user can press the menu button 1024 of the remote controller 102 to generate the request to trigger or hide the lists 1062, 1064, 1066.

To sum up, the display system, the method for Internet accessing and displaying of the webpage, and the method for controlling the display of the webpage utilize the processor to associate the list of webpage options with numbers (as shown in FIG. 2A, FIG. 2B, FIG. 2C, FIG. 3A, FIG. 3B, FIG. 3C, FIG. 3D, FIG. 4A, FIG. 4B, FIG. 4C, FIG. 4D, FIG. 5A, FIG. 5B, FIG. 5C, FIG. 5D) . Thus, the user can utilize the remote controller to control the operation of the display of the display system, instead of controlling a cursor displayed on the display to control the operation of the display of the display system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display system capable of Internet accessing, comprising:
a receiver for receiving a control signal from a remote controller; and
a display for displaying a list of webpage options with numbers associated with the webpage options, and displaying a webpage associated with a webpage option after receiving the control signal indicating a number corresponding to the webpage option;
wherein the number is entered through pressing a numerical keypad of the remote controller.

2. The display system of claim 1, further comprising:
a processor for associating the webpage options with the numbers.

3. The display system of claim 1, further comprising:
a server for associating the webpage options with the numbers.

4. The display system of claim 1, further comprising:
an Internet Service Provider for associating the webpage options with the numbers.

5. The display system of claim 1, wherein the receiver further receives a request for triggering display of the list of webpage options generated by the remote controller.

6. The display system of claim 1, further comprising:
a processor retrieving information of the webpage from the Internet after receiving the control signal.

7. The display system of claim 1, further comprising the remote controller, and wherein the remote controller comprises:
a page-up button for requesting display of a previous webpage; and
a page-down button for requesting display of a next webpage.

8. The display system of claim 1, further comprising the remote controller, and wherein the remote controller comprises:
a left-arrow button for requesting display of a previous webpage; and
a right-arrow button for requesting display of a next webpage.

9. A method for Internet accessing and displaying of a webpage, the method comprising:
receiving a number from a remote controller to select a webpage option associated with the number; and
displaying a webpage associated with the webpage option.

10. The method of claim 9, further comprising:
receiving a request from the remote controller to trigger display of a list of webpage options with numbers associated with the webpage options on a display.

11. The method of claim 10, wherein receiving the request through the remote controller is by pressing a menu button of the remote controller.

12. The method of claim 9, further comprising:
receiving another number from the remote controller to select a display option associated with the another number;
wherein displaying the webpage associated with the webpage option is displaying the webpage associated with the webpage option according to the display option.

13. The method of claim 9, further comprising:
using a processor to associate webpage options with numbers.

14. The method of claim 9, further comprising:
using a server to associate webpage options with numbers.

15. The method of claim 9, further comprising:
using an Internet Service Provider to associate webpage options with numbers.

16. The method of claim 9, further comprising:
associating webpage options with numbers according to frequencies of the webpage options being selected through the remote controller.

17. The method of claim 9, further comprising:
receiving a request through the remote controller to hide a list of webpage options.

18. A method for controlling display of a webpage, the method comprising:
associating a list of webpage options with numbers;
displaying the list of webpage options with the numbers associated with the webpage options on a display; and
displaying a webpage associated with a webpage option on the display after a number associated with the webpage option is entered through a numerical keypad.

19. The method of claim 18, further comprising:
associating a list of display options with numbers; and
displaying the list of display options with the numbers associated with the display options on the display after the number associated with the webpage option is selected;
wherein displaying the webpage associated with the webpage option on the display after the number associated with the webpage option is entered through the numerical keypad of the display is displaying the webpage associated with the webpage option on the display according to a display option after the number associated with the webpage option and a number associated with the display option are entered through the numerical keypad of the display.

20. The method of claim 18, wherein displaying the list of webpage options with the numbers associated with the webpage options on the display is displaying the list of webpage options with the numbers associated with the webpage options on a television.
